(19) United States
(12) Patent Application Publication
(10) Pub. No.: US 2012/0002510 A1
(43) Pub. Date: Jan. 5, 2012

(54) SYSTEM AND APPARATUS FOR AUTOMATICALLY ENSURING THE APPROPRIATE DURATION FOR HANDWASHING

(76) Inventor: Carl R. Berman, JR., Austin, TX (US)

(21) Appl. No.: 12/829,898

(22) Filed: Jul. 2, 2010

(51) Int. Cl. G04F 10/00; G04B 47/00

(52) U.S. Cl. 368/10; 368/109

(57) ABSTRACT

A method for automatically measuring elapsed time sufficient for complete hand washing, including actuating flowing of water, actuating a timer device, initiating washing hands, measuring a predetermined length of time, sounding an alarm when the predetermined length of time has elapsed, and ceasing washing hands after the alarm has sounded. The timer device further includes a housing portion, a timer portion positioned in the housing portion, a display portion positioned in the housing portion and operationally connected to the timer portion, and an alarm portion positioned in the housing portion and operationally connected to the timer portion. The timer portion is programmed to measure a predetermined length of time recommended for complete hand washing and actuates the alarm portion once the predetermined amount of time has elapsed.

### TECHNICAL FIELD

The novel technology relates generally to the field of personal hygiene and, specifically, to an apparatus for measuring a predetermined duration for the washing of hands to ensure proper cleaning and disinfection.

### BACKGROUND

One of the most common ways people become exposed to germs is through their hands. Everything touched by the hands represents a potential transfer of bacteria and viruses. As the hands contact objects, things and, especially, other people, germs are acquired and accumulated thereupon. One can infect oneself simply by touching one's own eyes, nose, mouth, mucous membranes, or open wound. Although it's impossible to keep the hands germ-free, washing the hands frequently can help minimize the number of germs carried thereupon, as well as limit the transfer of bacteria, viruses and other microbes. Further, germs may be passed on to others throughsuch activities as food preparation, tending to the sick, treating the wounds of the injured, and the like.

Consequently, frequent hand washing is the single best precaution that can be taken to avoid getting sick and spreading disease. Hand washing is simple and easy to do, requiring only soap and water. Hands should be washed whenever they become dirty, and especially following such activities as using the toilet, changing diapers, playing with children, blowing the nose, preparing food, handling animals, taking out the trash, having any contact with the sick or wounded, doing yard work, or the like. However, to maximize the removal of harmful germs, the hand washing process must be done for at least a minimum duration or about 20 seconds or so.

While hand washing is simple and easy to do, most people do not take sufficient time to remove all of the dirt and germs that could easily be removed. In such settings as hospitals, care giving facilities, and kitchens, it is both easy to pick up germs and critical that they are not passed along to infect others. Thus, there is a need for a system of reminding people to spend sufficient time washing their hands to maximize the removal of germs. The present invention addresses this need.

### SUMMARY

The present invention relates to a system and method for reminding hand washers to wash their hands for at least a predetermined minimum duration. One object of the present invention is to provide an improved means for timing the washing of hands. Related objects and advantages of the present invention will be apparent from the following description.

### BRIEF DESCRIPTION OF THE DRAWINGS

FIG. 1 is a first perspective view of a timer device according to a first embodiment of the present novel technology.

FIG. 2 is a second perspective view of the timer device of FIG. 1 as worn by a hand-washer.

FIG. 3 is a first perspective view of a timer device according to a second embodiment of the present novel technology.

FIG. 4 is a first perspective view of a timer device according to a third embodiment of the present novel technology.

FIG. 5 is a first perspective view of a timer device according to a fourth embodiment of the present novel technology.

FIG. 6 is a first perspective view of a timer device according to a fifth embodiment of the present novel technology.

FIG. 7 is a first perspective view of a timer device according to a sixth embodiment of the present novel technology.

### DESCRIPTION OF THE PREFERRED EMBODIMENTS

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

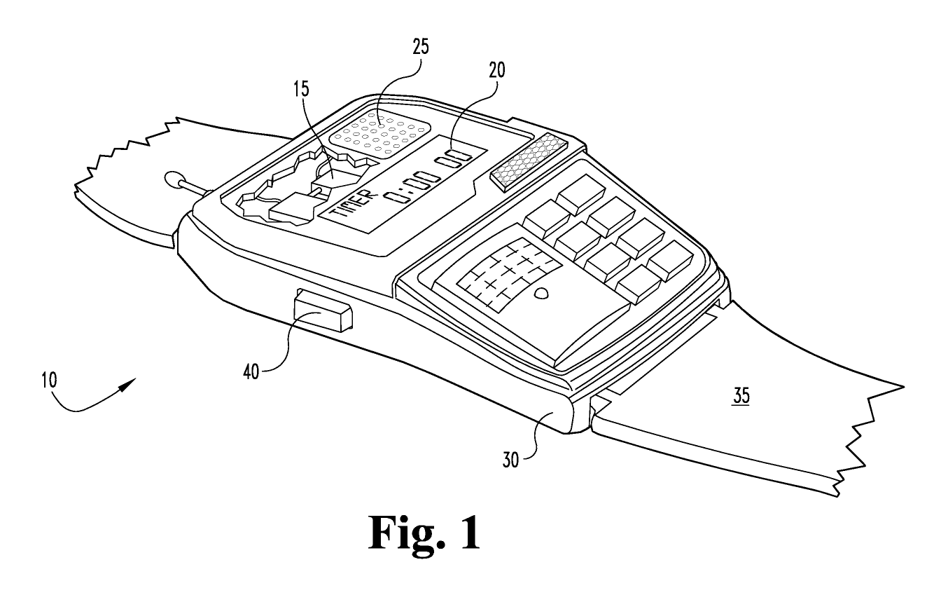

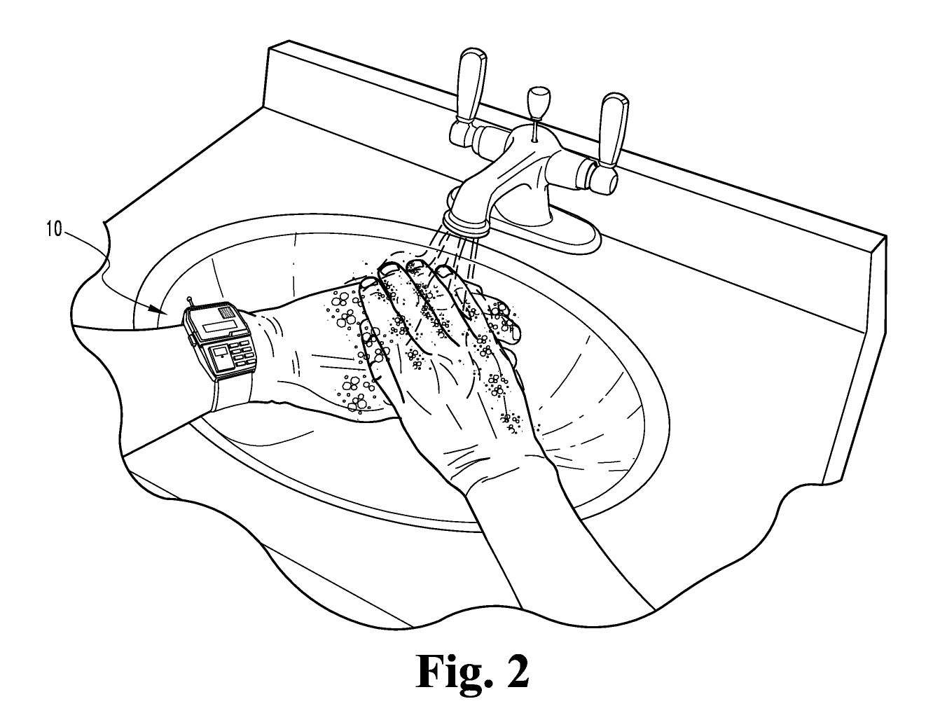

As illustrated in FIGS. 1 and 2, a first embodiment of the present novel technology relates to a system 10 for assisting a person in washing their hands for a predetermined minimum amount of time. The system includes a timer portion 15, a display portion 20 operationally connected to the timer portion 15, and an alarm or speaker portion 25 operationally connected to the timer portion 15. The timer portion 15 is typically a microprocessor. The timer, display and alarm portions 15, 20, 25 are typically positioned in a housing portion 30. The housing portion 30 is typically sealed and waterproof.

The timer portion 15 is typically preprogrammed to measure a predetermined duration of time, typically 20 seconds, long enough for the hand washing process to substantially remove topical germs and unwanted materials from the hands. In some embodiments, the duration is programmable; in other embodiments, the duration is fixed and cannot readily be altered by the wearer.

The system further includes a connection portion 35 for attaching the housing 30 to a wearer. This connection portion 35 typically may be a strap, clip, band or the like.

In operation, the system 10 functions as follows. A wearer connects the system 10 to himself via the connection portion 35. Just prior to washing his hands, the wearer activates the timer portion 15, such as by engaging an actuator 40 operationally connected to the timer portion 15. Typically, the display portion 20 indicates how much time has elapsed after activation of the timer portion 15. After the predetermined amount of time has elapsed, the timer portion 15 actuates the alarm portion 25 to provide a signal indicating that the wearer may now finish the hand washing process. The timer portion 15 may be programmed to play a tune through the or otherwise provide audible output through the speaker portion 25 for the duration of the predetermined amount of time, so as to let the wearer know that the hand-washing event has not yet ended. In other words, the wearer may stop washing his hands when the music stops.

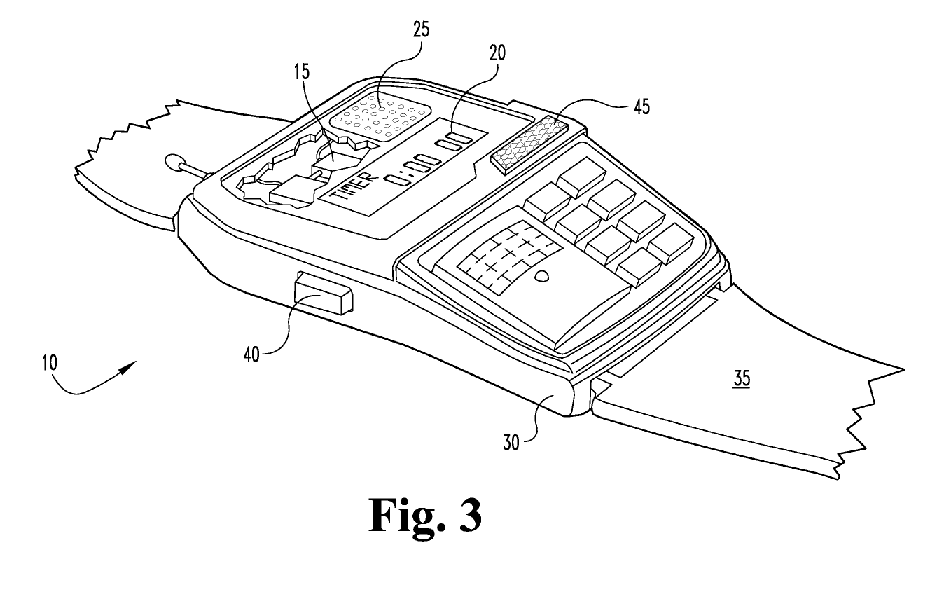

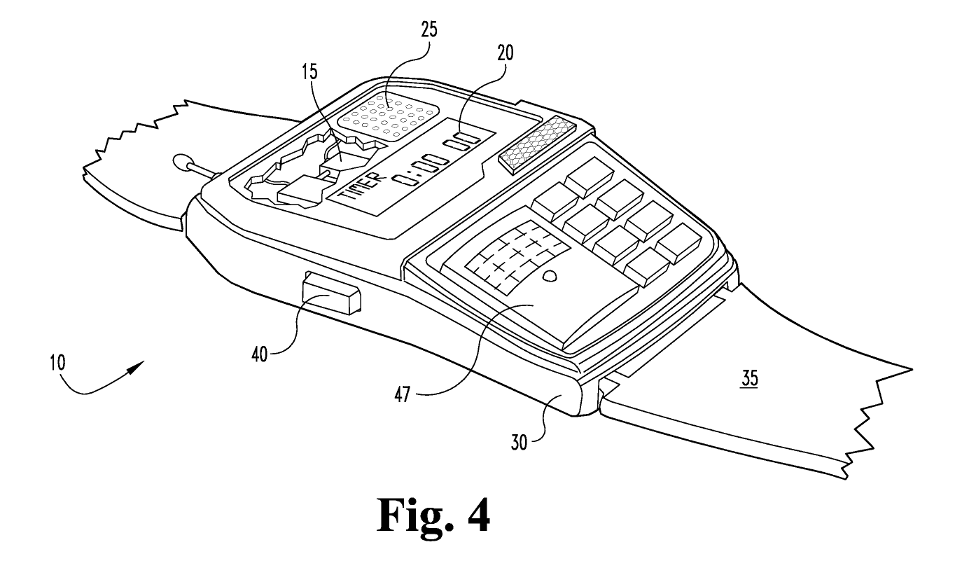

In one alternate embodiment, as illustrated in FIG. 3, the system 10 includes a moisture sensor 40 operationally connected to the timer portion 15, such that the timer portion 15 is automatically actuated by the moisture sensor 45 when the hand-washing process begins. Alternately, the sensor 45 could be configured to detect the sound of flowing water. In another contemplated embodiment, a motion sensor 47 may be operationally connected for detecting the continuous motions associated with hand-washing (see FIG. 4). The timer 15 would then be activated by the sound of the flowing water and/or the hand-washing motions. Further, an interruption of the hand washing process could be detected and a specific tone could be continuously generated by the alarm portion 25 until the total hand-washing time is satisfied. In other words, if a wearer stops washing his hands before the predetermined time duration has elapsed, the timer portion 15 receives a signal from the motion sensor 47 and pauses its countdown, and the alarm portion 25 receives a signal from the sensor 47 and/or the timer portion 15 and generates an alarm signal until the hand-washing event is continued, as evidenced by a signal from the motion sensor 47 and/or a signal from the timer portion 15 indicating that the countdown has resumed.

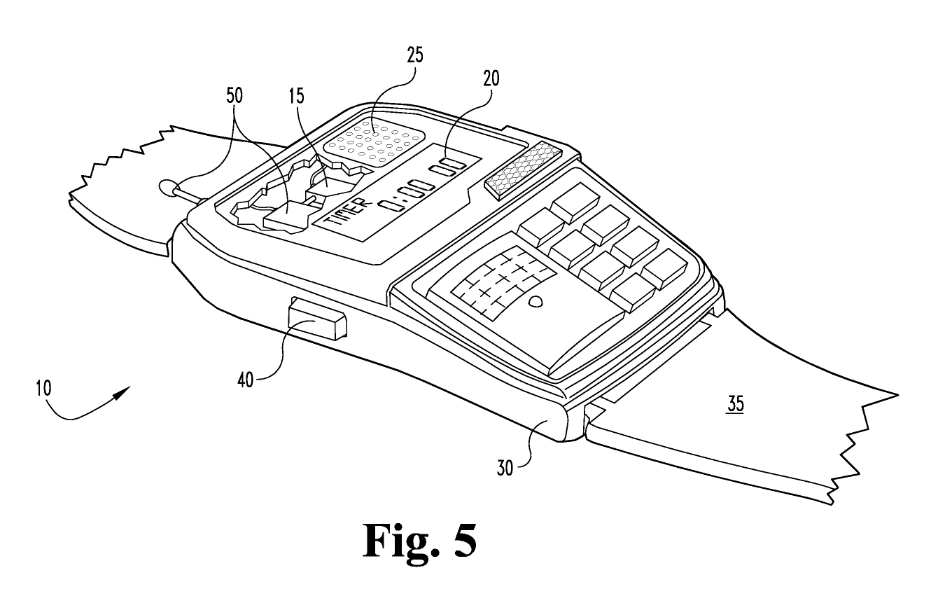

FIG. 5 illustrates another embodiment, wherein the system 10 includes a telemetry portion 50 operationally connected to the timer portion 15 for remote communication with the system 10, such that hand-washing events may be remotely monitored and/or prompted. The telemetry portion 50 may also be operationally connected to the alarm portion 25 such that hand-washing events may be remotely prompted.

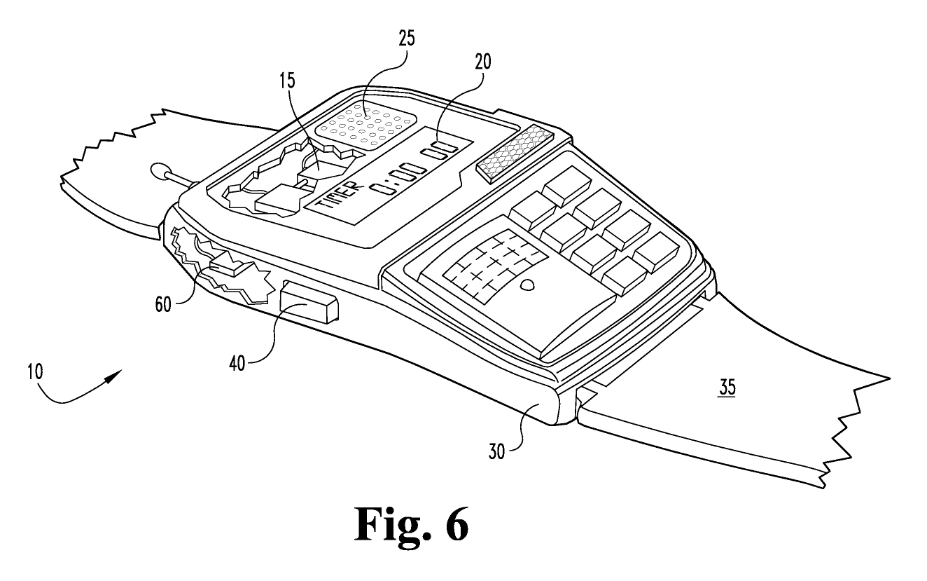

In another embodiment, as shown in FIG. 6, the system includes an RFID chip 60 or the like for sensing the proximity of an emitter. Such emitters may be positioned at the entrances of sensitive areas, such as clean rooms or ICU's. The RFID chip 60 is operationally connected to the alarm portion 25, such that when the RFID chip 60 is energized or actuated by proximity to the emitter, an alarm tone is generated by the alarm portion 25 to prompt the wearer to wash his hands. The alarm tone may be configured to continue until the timer portion 15 has measured the predetermined duration. This embodiment may also include the motion sensor 40 as described above such that the system 10 does not terminate the alarm tone until the predetermined hand washing duration has been satisfied as confirmed by the motion sensor 40.

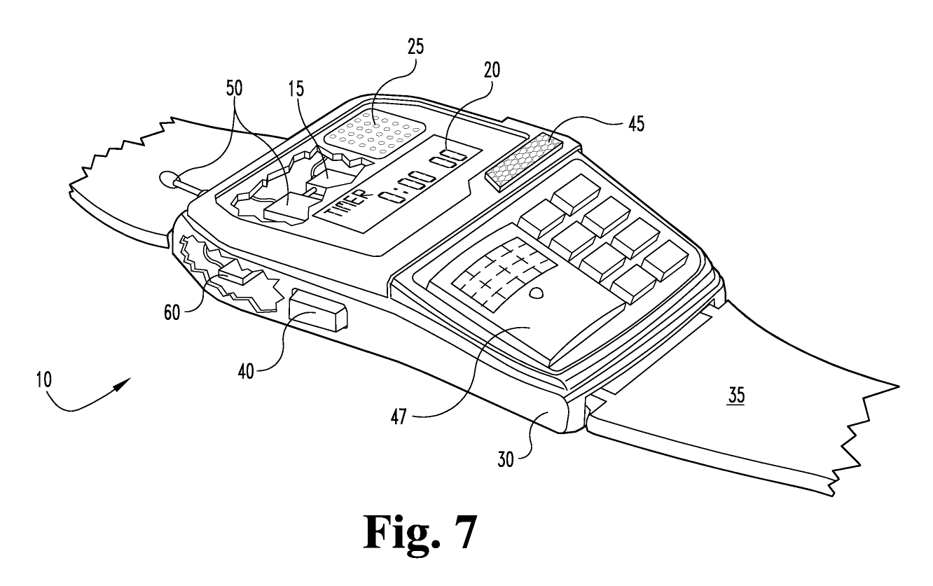

FIG. 7 illustrates a further embodiment wherein the system 10 includes a moisture sensor 45, a motion sensor 47, a telemetry transceiver 50, and an RFID device, as described separately above.

In some embodiments, the timer portion 15 may be additionally programmable to alert the wearer at different times, such as when to take a pill or when to perform a task. Typically, the alarm portion 25 will emit a different, distinct signal at such times.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. A system for automatically timing the duration of a hand-washing event to ensure thorough hand-washing, comprising:
a housing portion;
a timer portion positioned in the housing portion;
a display portion positioned in the housing portion and operationally connected to the timer portion; and
an alarm portion positioned in the housing portion and operationally connected to the timer portion;
wherein the timer portion is programmed to measure a predetermined length of time recommended for complete hand washing; and
wherein the timer portion actuates the alarm portion once the predetermined amount of time has elapsed.

2. The system of claim 1 and further comprising a connection portion connected to the housing portion for attaching the housing portion to a wearer.

3. The system of claim 1 wherein the timer portion is programmable to actuate the alarm portion at predetermined intervals.

4. The system of claim 3 wherein the timer portion may actuate the alarm portion to emit different tones at different intervals, wherein each respective tone may be coupled with a different event.

5. The system of claim 1 and further comprising an actuator operationally connected to the timer portion for initiating measurement of the predetermined length of time.

6. The system of claim 5 wherein the actuator is a switch.

7. The system of claim 5 wherein the actuator is a moisture sensor.

8. The system of claim 5 wherein the actuator is a motion sensor.

9. The system of claim 5 and further comprising a sensor operationally connected to the timer portion for detecting continuous hand-washing during the predetermined length of time.

10. The system of claim 5 and further comprising an RFID sensor operationally connected to the alarm portion for detecting an emitter and generating an alarm tone to prompt a hand washing event.

11. A method for automatically measuring elapsed time sufficient for complete hand washing, comprising:
a) actuating flowing of water;
b) actuating a timer device, wherein the timer device further comprises:
a housing portion;
a timer portion positioned in the housing portion;
a display portion positioned in the housing portion and operationally connected to the timer portion; and
an alarm portion positioned in the housing portion and operationally connected to the timer portion;
c) initiating washing hands;
d) measuring a predetermined length of time;
e) sounding an alarm when the predetermined length of time has elapsed;
f) ceasing washing hands after the alarm has sounded;
wherein the timer portion is programmed to measure a predetermined length of time recommended for complete hand washing; and
wherein the timer portion actuates the alarm portion once the predetermined amount of time has elapsed.

12. The method of claim 11 and further comprising a connection portion connected to the housing portion for attaching the housing portion to a wearer.

13. The method of claim 11 and further comprising an actuator operationally connected to the timer portion for initiating measurement of the predetermined length of time.

14. The method of claim 13 wherein the actuator is a switch.

15. The method of claim 13 wherein the actuator is a moisture sensor.

16. The method of claim 13 and further comprising:
g) during d), monitoring continuous washing;
h) sounding an alert tone if continuous washing is interrupted before the predetermined length of time has elapsed; and
i) terminating the alert tone when continuous washing has resumed;
wherein the timer device further comprises a sensor portion operationally connected to the timer portion.

17. The method of claim 13 and further comprising:
j) sending a hand washing prompt signal when the timer device is proximate a predetermined location; and
k) terminating the hand washing prompt signal when the predetermined length of time has elapsed.

18. The method of claim 13 and further comprising:
l) remotely communicating with the timer device.

19. A method for automatically confirming hand-washing for sufficient time to substantially clean the hands, comprising:
a) actuating a water flow;
b) actuating a timer device, wherein the timer device further comprises:
a housing portion;
a timer portion positioned in the housing portion;
a display portion positioned in the housing portion and operationally connected to the timer portion;
an alarm portion positioned in the housing portion and operationally connected to the timer portion; and
a sensor portion positioned in the housing portion and operationally connected to the timer portion for detecting continuous hand washing;
c) washing hands;
d) measuring a predetermined length of time;
e) confirming continuous hand washing during the predetermined length of time;
f) sounding an alert tone if hand washing is discontinued during the predetermined length of time; and
g) sounding an alarm when the predetermined length of time has elapsed;
wherein the timer portion is programmed to measure a predetermined length of time recommended for complete hand washing; and
wherein the timer portion actuates the alarm portion once the predetermined amount of time has elapsed.

20. The method of claim 19 and further compsiring:
h) sending a hand washing prompt signal when the timer device is proximate a predetermined location;
i) terminating the hand washing prompt signal when the predetermined length of time has elapsed; and
j) remotely communicating with the timer device.
